(19) United States
(12) Patent Application Publication
(10) Pub. No.: US 2006/0170601 A1
(43) Pub. Date: Aug. 3, 2006

(54) Mobile communication devices

(75) Inventor: Shyh-Tirng Fang, Tai-Nan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/299,143

(22) Filed: Dec. 9, 2005

Related U.S. Application Data
(60) Provisional application No. 60/648,261, filed on Jan. 28, 2005.

(51) Int. Cl. H01Q 1/24

(52) U.S. Cl. 343/702; 343/846

(57) ABSTRACT

A mobile communication device capable of changing its radiation pattern. An adjusting device is added to the mobile communication and coupled to the ground plane or shielding devices with equal potential to the ground plane, serving as an extended ground plane of the mobile communication device, thereby changing the radiation pattern thereof.

### CROSS REFERENCE TO RELATED APPLICATIONS

This application claims the full benefit and priority of provisional U.S. Patent Application Ser. No. 60/648,261, filed Jan. 28, 2005, entitled “Mobile communication devices”, inventor Fang, and incorporates the entire contents of said application herein.

### BACKGROUND

The invention relates in general to mobile communication devices, and more particularly to mobile communication devices capable of changing radiation pattern thereof by extending ground planes out of the main circuit boards of the mobile communication devices.

Mobile communication devices typically communicate through emitting radiation. Examples include GSM or CDMA mobile phones, PDAs, HPCs, and the like. Radiation efficiency is the most essential characteristic in evaluating performance of mobile communication devices. Generally, the shorter the equivalent distance the radiation signal can be transmitted, the lower the radiation efficiency is.

A horizontal transmission plane is considered to be an important reference for evaluation of radiation distance. The distance can be determined by observing the distribution of the radiation pattern in its horizontal transmission plane. For example, a mobile phone with an omni-directional radiation pattern in the horizontal transmission plane has a longer radiation distance than that with a directional radiation pattern.

FIGS. 1A and 1B show bar-type and folded-type mobile phones with exposed antennas (or external antennas). Each of the mobile phones 1 and 2 in FIGS. 1 and 2 comprises a front housing 11, a rear housing 12, a main circuit board 13 on which a base band (BB) module and a radio frequency (RF) module (or analog signal module) are provided, an exposed antenna 15, and a connection part 14 disposed on the main circuit board 13 for connecting the antenna 15. FIGS. 1C and 1D show bar-type and folded-type mobile phones 3 and 4 with embedded antennas (or internal antennas). The mobile phones 3 and 4 in FIGS. 1C and 1D comprise almost the same components or modules except for the embedded antenna 25 connected to the connection part 14. FIG. 2 schematically shows a main circuit board 13 inside any of the mobile phones in FIGS. 1A to 1D. In FIG. 2, the RF module, BB module and connection part 14 are disposed on the main circuit board 13.

FIG. 3 schematically shows the main current flow direction on the main circuit board 13. Since the connection part 14 is located at a corner of the main circuit board 13 and is very close to the RF module and the BB module, the main current flow 50 of these modules will be attracted toward the corner. Thus, while operating, the main current flow 50 will not be parallel with the extending direction of the antenna 15, causing an asymmetric radiation distribution on a horizontal transmission plane, and resulting in a directional radiation pattern.

On the other hand, taking a GSM mobile device as an example, the mobile phone mostly employs either a monopole antenna or a PIFA (Patched Inverse “F” Antenna), operating at ¼ wavelength due to its small size. It is understood that using a monopole antenna or PIFA for radiation requires the ground plane to provide image function, whereby the function of the half-wave length dipole is achieved and the omni-directional radiation pattern in the horizontal transmission plane is obtained. In general, mobile phones are about 70˜110 mm in length, which is similar to the length of the ground plane disposed in its main circuit board. For operating frequency of 900 MHz or 850 MHz, the ¼ wavelength is about 80˜90 mm, which is close to the length of the ground plane, and therefore an omni-directional radiation pattern can be obtained in the horizontal transmission plane when using the monopole antenna or PIFA at the frequency band. However, serious transmission problems occur at 1800 MHz or 1900 MHz operating frequency band. The ¼ wavelength for GSM mobile phones at 1800 MHz or 1900 MHz is less than 45 mm. That is, the length of the ground plane is longer than about twice that of the ¼ wavelength at the GSM 1800 MHz or 1900 MHz frequency. The radiation pattern provided by such mobile phone has extremely low intensity of electric field at the 90 degree region in the horizontal radiation transmission plane. In this situation, the radiation pattern will also be directional in the horizontal transmission plane, resulting in null electric field at specific angles and high probability of drop-call.

Accordingly, it is desired to have a mobile communication device containing an omni-directional radiation pattern in horizontal transmission plane as far as possible to avoid drop-call.

### SUMMARY

A mobile communication device capable of changing its radiation pattern is provided. An adjusting device is added to the mobile communication and coupled to the ground plane or shielding devices with equal potential to the ground, serving as an extended ground plane of the mobile communication device, thereby changing the radiation pattern thereof.

To achieve the above object, the invention provides a mobile communication device which comprises a main circuit board at least having a ground plane; and an adjusting device having at least a conduction member, electrically coupled to the ground plane, for changing the radiation characteristic of the mobile communication device.

To achieve the above object, the invention provides another mobile communication device which comprises a main circuit board at least having a ground plane and one or more potential units with potentials equal to that of the ground plane; and an adjusting device having at least a conduction member, electrically coupled to at least one of the potential units, for changing the radiation characteristic of the mobile communication device.

### DESCRIPTION OF THE DRAWINGS

The invention will become more fully understood from the detailed description, given hereinbelow, and the accompanying drawings. The drawings and description are provided for purposes of illustration only and, thus, are not intended to be limiting of the present invention.

FIGS. 1A and 1B show conventional bar-type and folded-type mobile phones with exposed antennas (or external antennas).

FIGS. 1C and 1D show conventional bar-type and folded-type mobile phones with embedded antennas (or internal antennas).

FIG. 2 schematically shows the conventional mobile phones of FIGS. 1A to 1D without showing the antenna, when opening the rear housing 12.

FIG. 3 schematically shows a mobile phone according to the invention, when opening its rear housing.

FIGS. 4A, 4B, 4C, 5, 6, 7, 8, 9A, 9B, 10A and 10B respectively show exemplary embodiments of the mobile phones according to the invention.

FIG. 11 depicts two curves showing EIRP distribution in the horizontal transmission plane of mobile phones, operating at a frequency of 1747 MHz.

FIG. 12 depicts two curves showing EIRP distribution in the horizontal transmission plane of mobile phones, operating at a frequency of 1785 MHz.

FIGS. 13A and 13B show the 3D radiation pattern of a conventional mobile phone using exposed antenna (or external antenna), operating at frequency 1747 MHz.

FIGS. 14A and 14B show the 3D radiation pattern of a mobile phone according to the invention using exposed antenna (or external antenna), operating at a frequency of 1747 MHz.

FIG. 15 shows a preferred connecting position of the metal sheet.

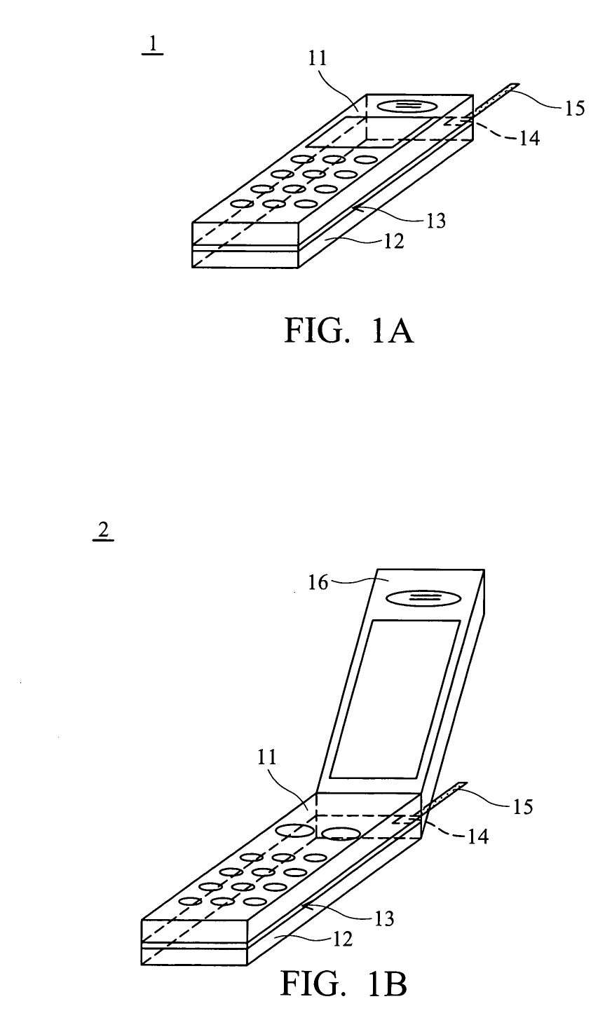

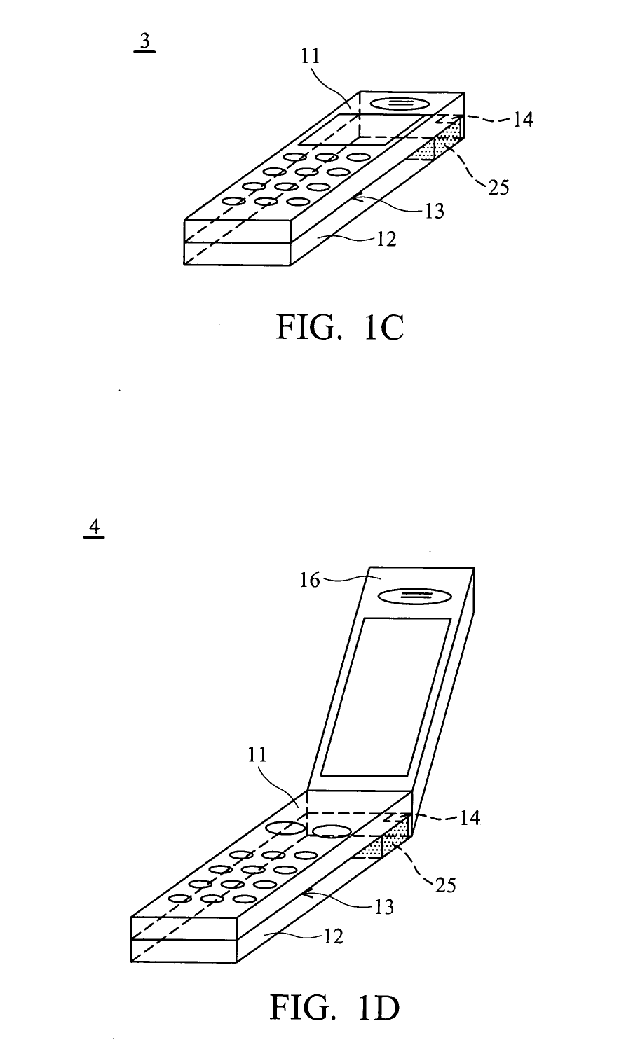

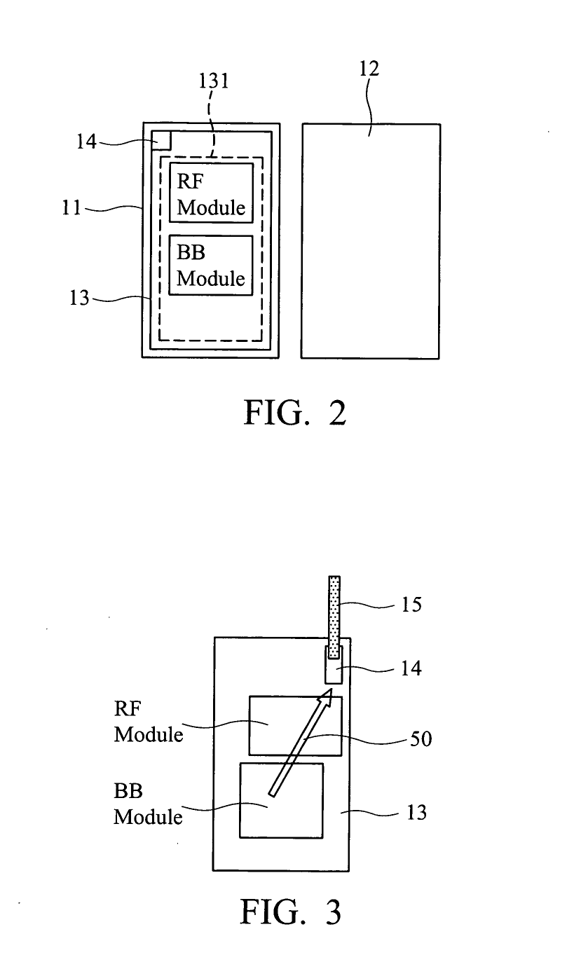

### DETAILED DESCRIPTION OF THE INVENTION

For brevity, mobile phones are taken as examples to describe the invention. Applications of the invention however should not be limited to mobile phones. Any wireless device containing at least an antenna for emitting radiation should be covered by the claimed invention.

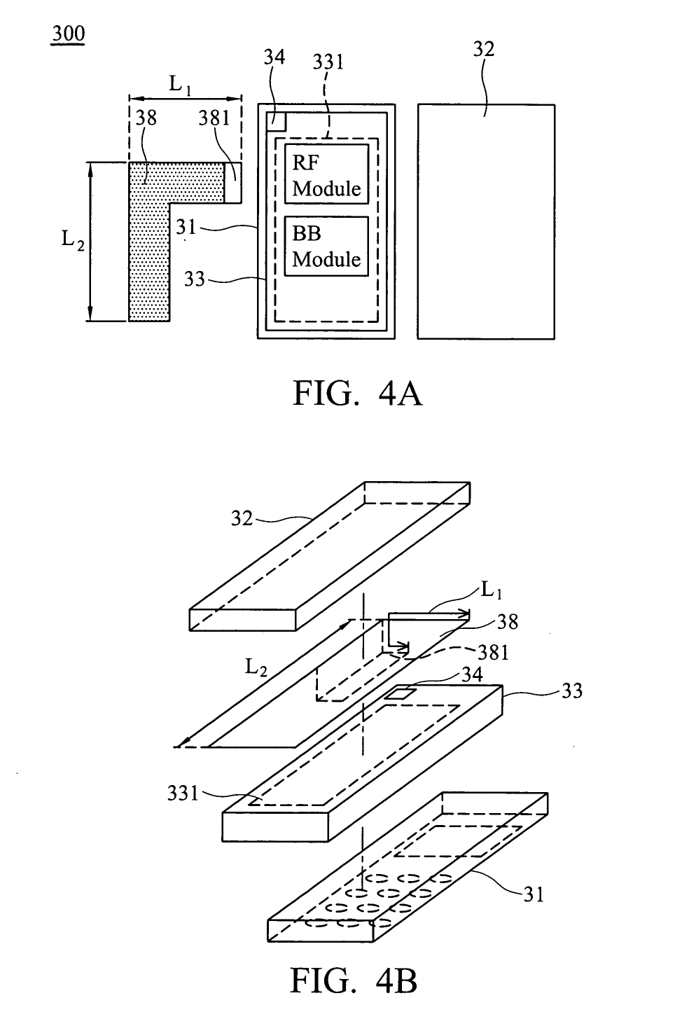

FIG. 4A schematically shows a mobile phone according to the invention. The mobile phone 300 comprises a front housing 31, a rear housing 32, and an embedded antenna or exposed antenna (not shown in FIG. 4A) connected to a connection part 34. The mobile phone 300 further comprises a RF module (or analog signal module) and a BB (base band) module. The mobile phone 300 further comprises a main circuit board 33 having at least a ground plane 331. The ground plane 331 serves as reference ground of the mobile phone 300. The ground plane 331 can be formed on the surface of the main circuit board 31, close to the rear housing 32, as shown in FIG. 4B. Or, the ground plane 331 can be formed inside the main circuit board 31, coupling to another ground plane 332 formed on the main circuit board 33, as shown in FIG. 4C; wherein the two ground planes 331 and 332 are electrically connected via connections 333 disposed in the main circuit board 33. The RF module, the BB module, and the connection part 34 are all disposed on the main circuit board 33, which are not shown in FIGS. 4B and 4C. In the invention, the mobile phone 300 further comprises an adjusting device having at least a conduction member 38, electrically coupled to the ground plane 331, for changing the radiation pattern of the mobile phone 300.

In some embodiments, the conduction member 38 is coupled to the ground plane 331 of the mobile phone 300, such that the conduction member 38 with equal potential as that of the ground plane 331 serves as an extended ground of the main circuit board 33. Thus, the main current flow on the main circuit board 33 can be adjusted by the conduction member 38 to provide an omni-directional radiation pattern in the horizontal transmission plane to avoid drop-call.

In this invention, the shape of the conduction member 38 is not limited. In some embodiments, it might be disposed or folded inside the chamber formed by the front and rear housings 31 and 32.

In some embodiment, the conduction member 38 is a metal sheet with length L or has at least two segmented sheets connected together (such as depicted in FIG. 4A with length L₁+L₂). It should be noted that the length or size of the conduction member 38 is related to the operating wavelength of the mobile phone. Generally, the higher the operating frequency band, the shorter the length of the conduction member 38 is. Preferably, the length of the metal sheet (the conduction member 38) is substantially equal to ¼ times the operating wavelength of the mobile phone. That is, the length (L₁+L₂ in FIG. 4A) of the conduction member 38 is equal to ¼ times the operating wavelength at the operating frequency band at which the intensity drop of electric radiation occurs in the horizontal transmission plane.

In FIG. 4C, two ground planes 331 and 332 are provided in the main circuit board 33 and both are connected through the via connections 333. Therefore, the two ground planes 331 and 332 have equal electric potential. In this embodiment, instead of directly connecting to the ground plane 331, the metal sheet 38 connects to the ground plane 332 via a portion 381. Thereby, the metal sheet 38 will have an electrical potential equal to the two ground planes 331 and 332.

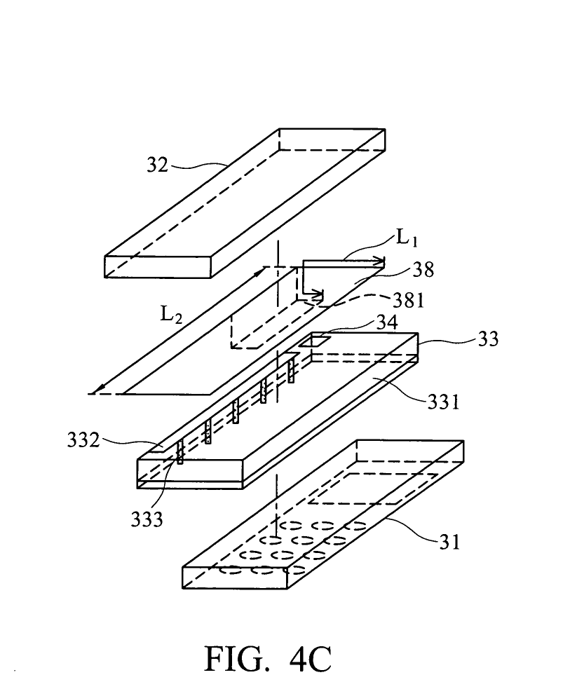

FIG. 5 is a schematic diagram showing current distribution (or current flow) of the mobile phone using the adjusting device (metal sheet) of the invention. In FIG. 5, the metal sheet 38 connects the ground plane 331 or the shielding device (not shown in FIG. 5), such that the metal sheet 38 serves as an extending ground plane of the mobile phone. When the mobile phone and the antenna 35 operate, the current flow 50 distributes almost in parallel with the extending direction of the antenna 35. Because the current flow 50 is almost perpendicular to the horizontal transmission plane of the mobile phone, therefore the radiation pattern measured on the horizontal transmission plane of the mobile phone is approximately omni-directional. In addition, the metal sheet enlarges the total ground plane to comply with ¼ wavelength of the mobile phone operating at 1800˜1900 MHz, thereby achieving function of half-wave length dipole and obtaining an omni-directional radiation pattern in the horizontal transmission plane.

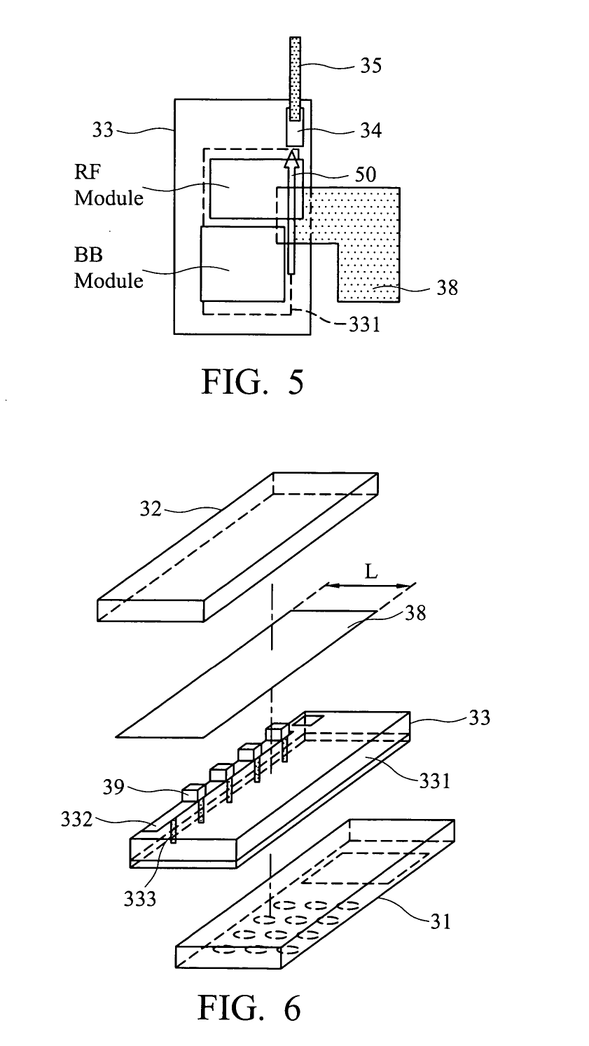

In FIG. 6, the metal sheet 38 is a rectangular sheet with length L, and is mounted on one (inner) surface of the rear housing 32. After assembling the rear housing 32, the metal sheet 38 will electrically connect to the ground plane 332 through the conduction parts 39 which are usually made of elastic material, such as a conductive sponge, to improve reliability of assembling.

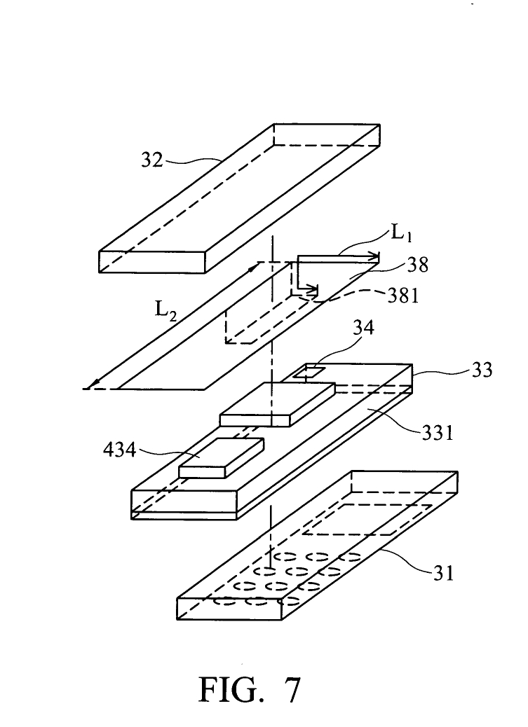

Some mobile phones further comprise at least a shielding device 434 to shield electromagnetic waves, which could be a metal case. The shielding device 434 has an electrical potential equal to that of the ground plane by directly connecting to any ground plane disposed on the main circuit 33 or paths and devices with electrical potential equal to that of the ground plane 331, as shown in FIG. 7.

In FIG. 7, it is assumed that the shielding device 434 has an electric potential equal to the ground plane 331. By directly connecting to the shielding devices 434, the well folded metal sheet 38 (with length L1+L2), electrically coupled to the ground plane 331 through the connecting portion 381 of the metal sheet 38, has equal electrical potential to that of the ground plane 331.

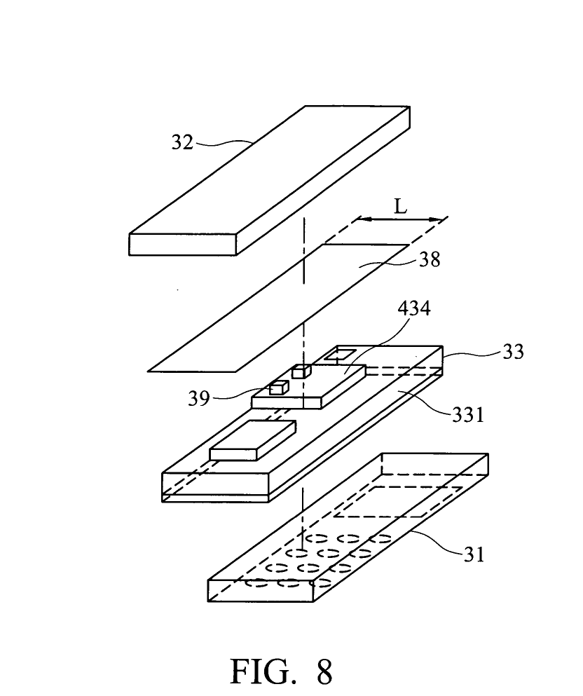

In FIG. 8, the metal sheet 38 is a rectangular sheet with length L, and is mounted on one surface of the rear housing 32. After assembling the rear housing 32, the metal sheet 38 is connected to the shielding device 434 through conduction parts 39 which are usually made of elastic material such as a conductive sponge to improve reliability of assembling.

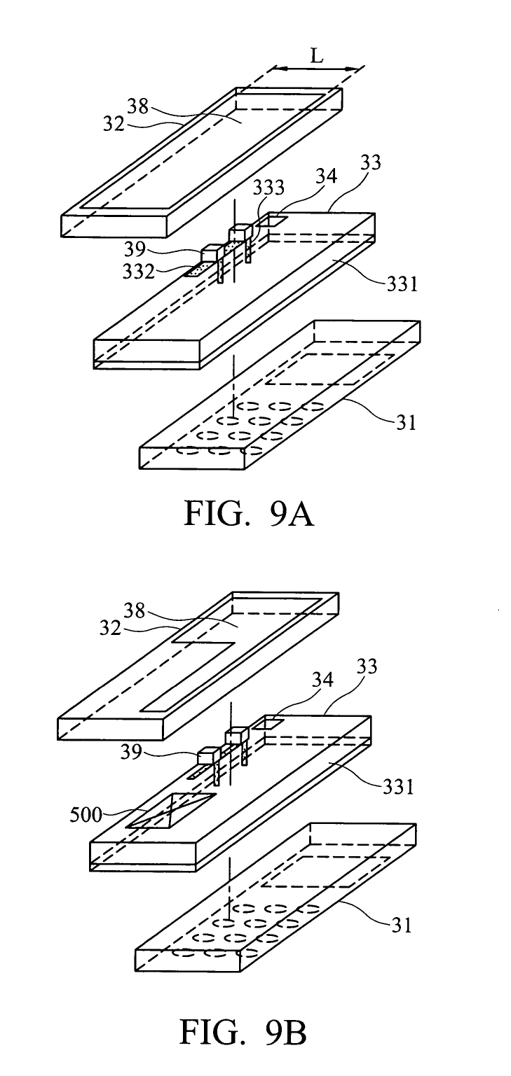

In FIG. 9A, two ground planes 331 and 332 are provided in the main circuit board 33 and both are connected through the connections 333. The metal sheet 38 is a rectangular sheet with length L and formed on one surface of the rear housing 32 by printing or coating conductive materials on the rear housing 32. After assembling the rear housing 32, the metal sheet is connected to the ground plane 332 through conduction parts 39. The rectangular sheet may overlay the SIM-card holding region provided on the main circuit board 33. To avoid short-circuiting of the metal sheet 38 and the SIM-card holding region 500, the metal sheet 38 can be formed with two segmented sheets (or in “L” shape), as shown in FIG. 9B.

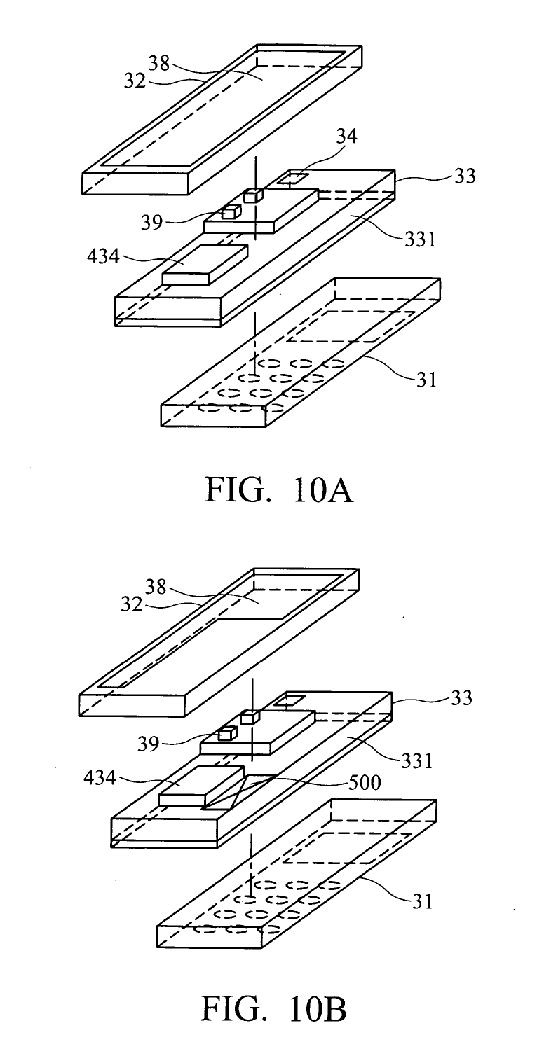

In FIG. 10A, the metal sheet 38 is the same as that described in FIG. 9A. After assembling the rear housing 32, the metal sheet 38 is connected to the shielding device 434 through conduction parts 39. To avoid short-circuiting of the metal sheet 38 and the SIM-card holding region 500, the metal sheet 38 can be formed with two segmented sheets (or in “L” shape), as shown in FIG. 10B.

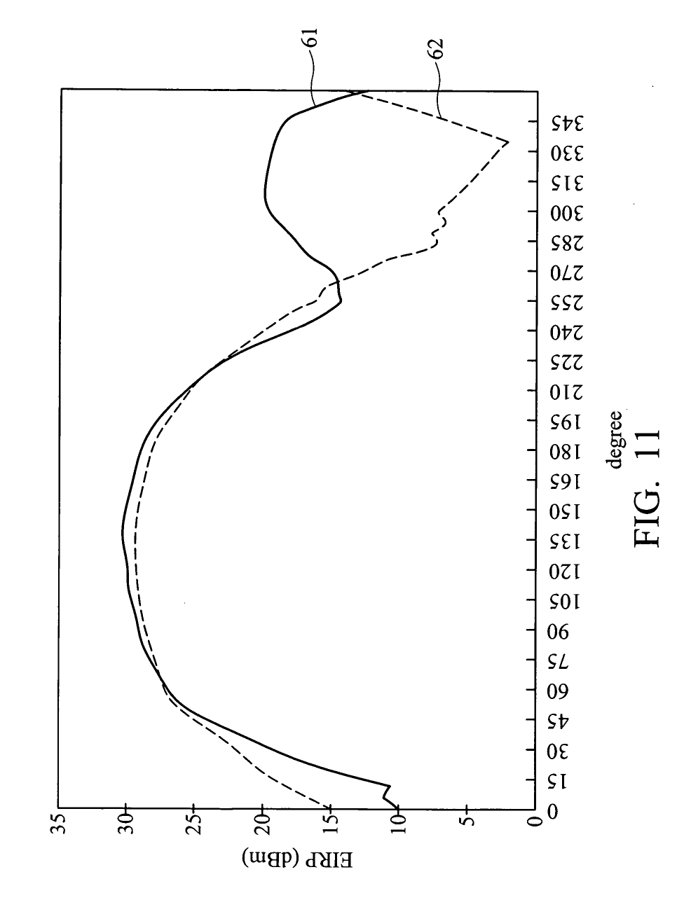

FIG. 11 depicts two curves showing EIRP (Equivalent Isotropically Radiated Power) distribution in horizontal transmission plane of mobile phones. Curve 62 shows the EIRP distribution of a conventional mobile phone in the DCS 1800 MHz operating band while operating at frequency close to 1747 MHz. It is obvious that the EIRP drops dramatically to lower than 10 dBm, at angles of about 270 to 360 degree. A mobile phone according to the invention, further comprises an adjusting device such as a metal sheet added therein with a length of 42.9 mm (about ¼ the wavelength at 1747 MHz), coupled to any one ground plane or shielding device of the main circuit board in the mobile phone. Curve 61 shows the EIRP distribution of the mobile phone according to the invention at the operating band of DCS 1800 MHz while operating at frequency close to 1747 MHz. It is obvious that the EIRP does not drop but is improved to above 15 dBm at angle between about 270 to 360 degrees.

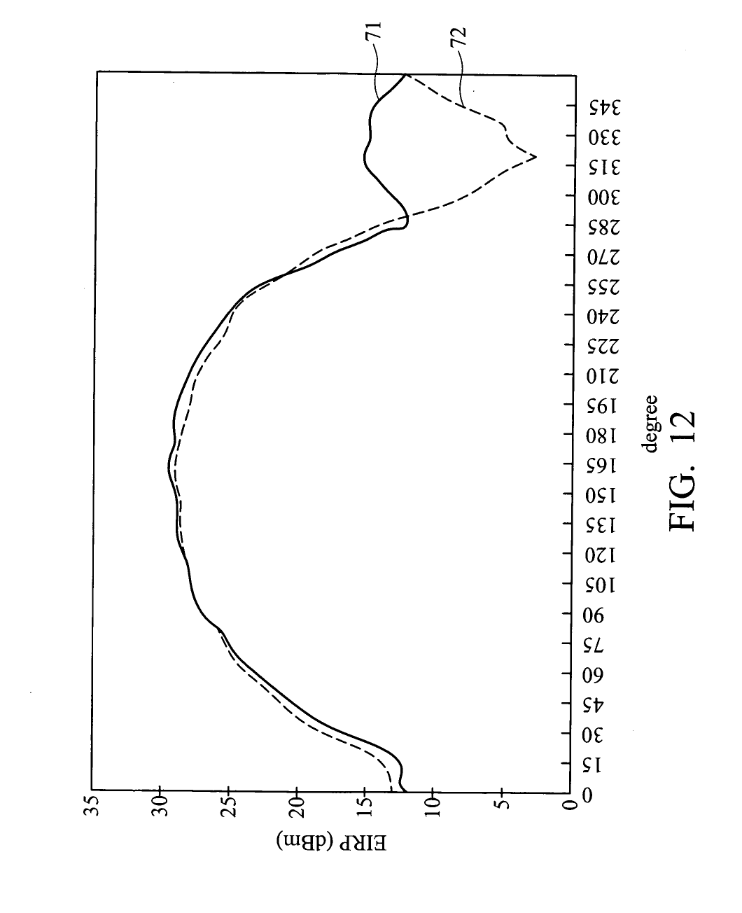

FIG. 12 depicts two curves showing EIRP distribution in the horizontal transmission plane. Curve 72 shows the EIRP distribution of a conventional mobile phone at operating band of DCS 1800 MHz while operating at frequency close to 1785 MHz. It is obvious that the EIRP drops dramatically to lower than 10 dBm, at angles between about 285 to 360 degree. Another mobile phone according to the invention, further comprises an adjusting device such as a metal sheet added therein with a length of 41.9 mm (about ¼ the wavelength at 1785 MHz), coupled to any one ground plane or the shielding device of the main circuit board in the mobile phone. Curve 71 shows the EIRP distribution of the mobile phone according to the invention at operating band of DCS 1800 MHz while operating at frequency close to 1747 MHz. It is obvious that the EIRP does not drop but is improved to above 15 dBm at angles between about 285˜360 MHz.

In view of FIGS. 11 and 12, it is clear that mobile phones using the adjusting device (such as a metal sheet) can change the radiation pattern thereof and make it become almost omni-directional, thereby improving communication performance.

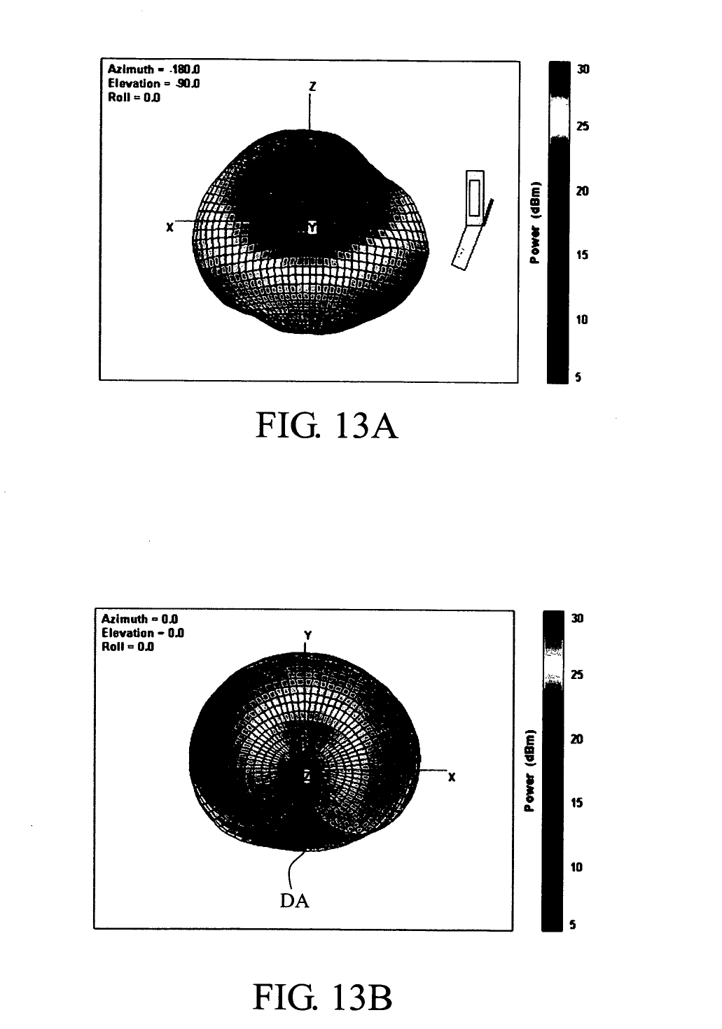

FIGS. 13A and 13B show the 3D radiation pattern of a conventional mobile phone using an exposed antenna (or external antenna), operating at frequency of 1747 MHz. The X-Y plane is the horizontal transmission plane of the conventional mobile phone, and the direction of +Z substantially is the extended direction of the exposed antenna. In view of FIG. 13A, it is clear that the radiated power is not mainly concentrated on the X-Y plane, and much of the radiated power is distributed along Z direction. In view of FIG. 13B, an angle region of about 90 degrees (indexed as DA) is found with lower EIRP distribution than 10 dBm corresponding to curve 62 of FIG. 11.

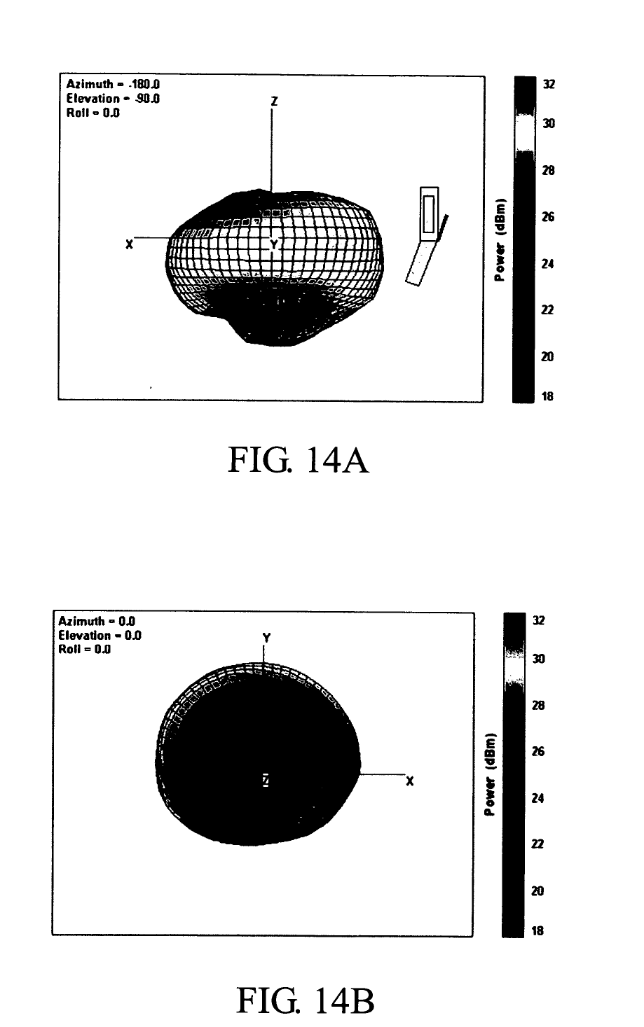

FIGS. 14A and 14B show the 3D radiation pattern mobile phone according to the invention using an exposed antenna (or external antenna), operating at frequency of 1747 MHz. Referring to FIG. 14A, it is clear that the radiated power is more concentrated on the X-Y plane, and less radiated power is distributed along the Z direction, when compared with FIG. 13A. Referring to FIG. 14B, EIRP distribution in X-Y plane is more uniform than that in FIG. 13B, without an angle region of lower EIRP distribution lower than 10 dBm.

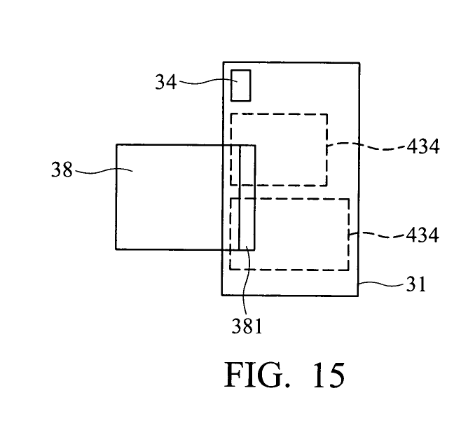

The connection portion 381 of the adjusting device (such as metal sheet 38) is preferably disposed at the same side of the front housing 31 with connection part 14 as shown in FIG. 15, when the metal sheet 38 is coupled to the shielding devices 434 or the ground plane (not shown in FIG. 15). Furthermore, the metal sheet 38 is coupled to the ground plane or shielding device in open loop form, i.e., the metal sheet 38 and the ground plane (or the shielding device) will not form a closed loop.

The foregoing descriptions of several exemplary embodiments have been presented for the purpose of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A mobile communication device, comprising:
a main circuit board at least having a ground plane; and
an adjusting device having at least a conduction member, electrically coupled to the ground plane, for changing the radiation characteristic of the mobile communication device.

2. The mobile communication device as claimed in claim 1, wherein the conduction member is a metal sheet.

3. The mobile communication device as claimed in claim 2, wherein the length of the metal sheet substantially equals ¼ the operating wavelength of the mobile communication device.

4. The mobile communication device as claimed in claim 2, wherein the metal sheet has at least two segmented sheets connected together and the total length of the two segmented sheets is substantially equal to ¼ the operating wavelength of the mobile communication device.

5. The mobile communication device as claimed in claim 2, further comprises a housing, wherein the metal sheet is formed on a surface of the housing.

6. The mobile communication device as claimed in claim 5, wherein the metal sheet is formed by printing or coating a metal layer on the surface of the housing.

7. The mobile communication device as claimed in claim 5, wherein the metal sheet is directly connected to the ground plane or indirectly connected to the ground plane through conduction parts.

8. The mobile communication device as claimed in claim 2, wherein the metal sheet is directly connected to the ground plane or indirectly connected to the ground through conduction parts.

9. The mobile communication device as claimed in claim 2, further comprises a housing and an antenna arranged inside or outside the housing.

10. The mobile communication device as claimed in claim 1, wherein the potential of the conduction member is substantially equal to that of the ground plane.

11. The mobile communication device as claimed in claim A1, wherein the conduction member coupled to the ground plane is open loop.

12. A mobile communication device, comprising:
a main circuit board at least having a ground plane and one or more potential units with potentials equal to that of the ground plane; and
an adjusting device having at least a conduction member, electrically coupled to at least one of the potential units, for changing the radiation characteristic of the mobile communication device.

13. The mobile communication device as claimed in claim 12, wherein the conduction member is a metal sheet.

14. The mobile communication device as claimed in claim 13, the length of the metal sheet substantially equals ¼ the operating wavelength of the mobile communication device.

15. The mobile communication device as claimed in claim 13, wherein the metal sheet has at least two segmented sheets connected together and the total length of the two segmented sheets is substantially equal to ¼ the operating wavelength of the mobile communication device.

16. The mobile communication device as claimed in claim 13, further comprises a housing, wherein the metal sheet is formed on a surface of the housing.

17. The mobile communication device as claimed in claim 16, wherein the metal sheet is formed by printing or coating a metal layer on the surface of the housing.

18. The mobile communication device as claimed in claim 16, wherein the metal sheet is directly connected to the potential unit or indirectly connected to the potential unit through conduction parts.

19. The mobile communication device as claimed in claim 13, wherein the metal sheet is directly connected to the potential unit or indirectly connected to the potential unit through conduction parts.

20. The mobile communication device as claimed in claim 13, further comprises a housing and an antenna arranged inside or outside the housing.

21. The mobile communication device as claimed in claim 12, wherein the potential of the conduction member is substantially equal to that of the potential unit.

22. The mobile communication device as claimed in claim 12, wherein the conduction member is in an open-loop shape, coupled to the ground plane.

23. The mobile communication device as claimed in claim 12, wherein the potential unit is a shielding conductor for shielding an electromagnetic wave.
